(19) United States
(12) Patent Application Publication
(10) Pub. No.: US 2014/0162133 A1
(43) Pub. Date: Jun. 12, 2014

(54) HIGH CAPACITY LEAD ACID BATTERY

(71) Applicant: Xiaogang Wang, Troy, MI (US)

(72) Inventor: Xiaogang Wang, Troy, MI (US)

(21) Appl. No.: 14/103,136

(22) Filed: Dec. 11, 2013

Related U.S. Application Data
(60) Provisional application No. 61/736,189, filed on Dec. 12, 2012.

(51) Int. Cl. H01M 4/73; H01M 10/10; H01M 10/18

(52) U.S. Cl. CPC H01M 4/73; H01M 10/18; H01M 10/10
USPC 429/300; 429/233; 429/211; 429/210

(57) ABSTRACT

A high capacity lead acid battery includes a hybrid electrolyte system and a complex grid system. The hybrid electrolyte system includes an acid gel and adsorbed glass mat. The complex grid system includes a normal grid, a sub-grid and a basement.

### CROSS-REFERENCE TO RELATED APPLICATION(S)

The present invention claims the priority date of co-pending U.S. Provisional Patent Application Ser. No. 61/736,189, filed Dec. 12, 2012.

### BACKGROUND OF THE INVENTION

1. Field of the Invention

The present invention relates generally to batteries and, more specifically, to advanced high capacity lead acid batteries used for vehicles and solar and wind energy storages having low cost and long cycle life.

2. Description of the Related Art

It is known to increase the capacity of a lead acid battery in monopolar configuration by increasing the number of electrode plates and/or an area of the electrode plates. For a bipolar lead acid battery, it is not possible to increase a capacity of the battery by increasing the number of the electrode plates. Increasing the area of the electrode plate is the only way to increase the capacity of the battery. However, increasing the area of the electrode plates is limited by the mechanical property and the shape and size of the battery in the applications. Increasing a thickness of the active materials may increase the battery capacity, but the thick active materials hamper the acid penetrating/diffusing into the whole active materials, which increases the internal resistance and decreases the power output and utilization of the active materials as well. This is why a conventional bipolar lead acid battery has a relatively small capacity.

It is desirable to provide a lead acid battery with a very large capacity, especially to build a bipolar lead acid battery with a very large capacity. It is also desirable to provide a lead acid battery with low cost and long cycle life.

### SUMMARY OF THE INVENTION

It is, therefore, one object of the present invention to provide new lead acid batteries with high capacity for vehicles and solar and wind energy storages.

It is another object of the present invention to provide a new lead acid battery having a low cost and long cycle life.

To achieve one or more of the foregoing objects, the present invention is a lead acid battery including a complex grid system and a hybrid electrolyte system.

Further, the present invention is a complex grid system for a lead acid battery including a normal grid, a sub-grid, and a basement. The complex grid system can be made by a Pb-Sn composite with a micro-grid internal structure.

In addition, the present invention is a hybrid electrolyte system for a lead acid battery including a sulfuric acid gel and adsorbed glass mat. The gel is in the grid and the adsorbed glass mat is in between the electrode plates.

One advantage of the present invention is that a new lead acid battery having a high capacity is provided. Another advantage of the present invention is that the lead acid battery has a low cost and long cycle life. Yet another advantage of the present invention is that the lead acid battery has a low cost meaning that the total cost of the lead acid battery for dollars per Watt-hour ($/Wh) is close to that of a current commercial lead acid battery. Yet another advantage of the present invention is that the lead acid battery uses inexpensive materials for the current collectors, and low cost methods of manufacturing the current collectors and batteries.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1a is a front view of an electrode plate having a complex grid system, according to the present invention.

FIG. 1b and FIG. 1c are the bottom and side cross-sectional views of FIG. 1a illustrating terminal plate configuration for the complex grid system of FIG. 1a.

FIG. 2a is a bottom cross-sectional view of FIG. 1a illustrating an intermediate plate configuration for the complex grid system of FIG. 1a.

FIG. 2b is a side cross-sectional view of FIG. 1a illustrating an intermediate plate configuration for the complex grid system of FIG. 1a.

FIG. 3 is a fragmentary view of a monopolar configuration for the lead acid batteries, according to the present invention.

FIG. 4 is a fragmentary view of a bipolar configuration for the lead acid batteries, according to the present invention.

FIG. 5 illustrates the electrode with the grid structure of a rectangular pattern, which has been pasted with the active material, for the lead acid batteries, according to the present invention.

FIG. 6a illustrates a Pb-Sn micro-grid composite for the lead acid batteries, according to the present invention.

FIG. 6b is a bottom cross-sectional view of the Pb-Sn micro-grid composite of FIG. 6a.

FIG. 6c is a side cross-sectional view of the Pb-Sn micro-grid composite of FIG. 6a.

FIG. 7a is a view illustrating the Pb-Sn micro-grid composite with a micro-grid of a rectangular pattern.

FIG. 7b is a view illustrating the Pb-Sn micro-grid composite of FIG. 6a with a micro-grid of a circle pattern.

### DESCRIPTION OF THE PREFERRED EMBODIMENT(S)

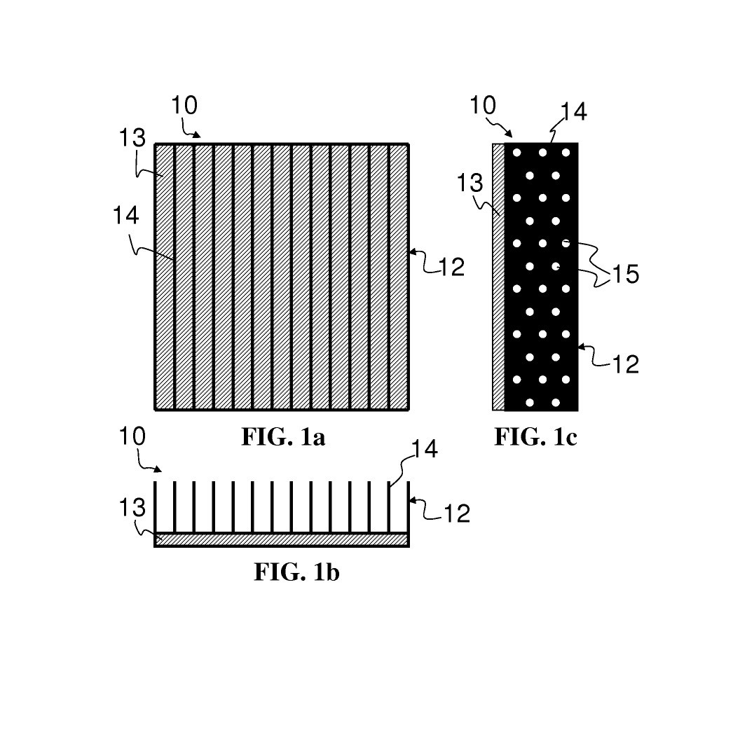

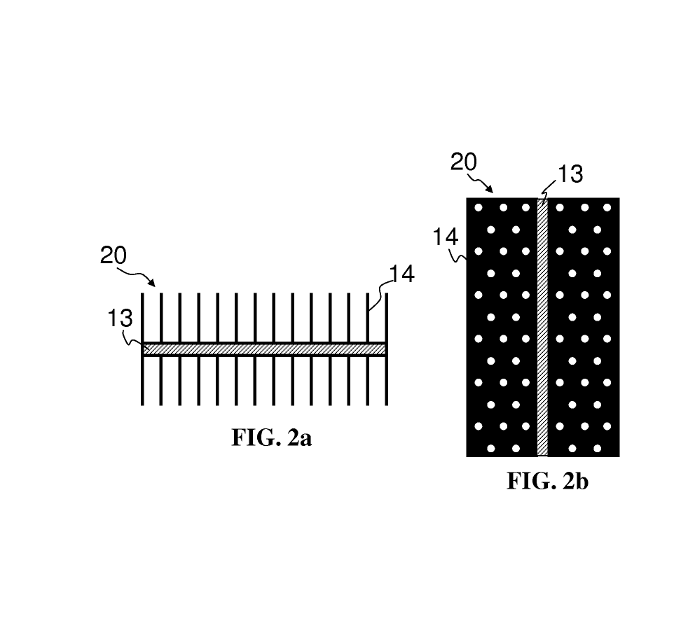

Referring to FIGS. 1a through 1c, one embodiment of an electrode plate, generally shown at 10, having a complex grid system, generally indicated at 12, for a lead acid battery, according to the present invention, is shown. As illustrated, the complex grid system 12 for the electrode plate 10 includes a basement 13 and a grid 14. The grid 14 can be made by the polymer coated with conductive and corrosion resistant film, lead/lead alloy, conductive and corrosion resistant composites, or other conductive and corrosion resistant materials. As illustrated in FIG. 1c, the edges of the grid 14 include a sub grid structure, which has a pattern of circles 15. The diameter of the circles can be from approximately 0.5 mm to approximately 10 mm. The pattern for the sub-grid can be any other suitable pattern, such as a diamond, honeycomb, and/or rectangular pattern. The basement 13 can be made by lead/lead alloy, other metals coated with conductive and corrosion resistant film, conductive and corrosion resistant composites, or other conductive and corrosive resistant materials. It should be appreciated that FIG. 1b and FIG. 1c illustrate a terminal plate configuration for the electrode plate 10. It should also be appreciated that FIG. 2a and FIG. 2b illustrate an intermediate plate configuration for the electrode plate 10. It should further be appreciated that the height of the complex grid system 12 (the distance from the basement 13 to the top surface of the electrode plate 10) controls the capacity of the battery and increasing the height can increase the capacity.

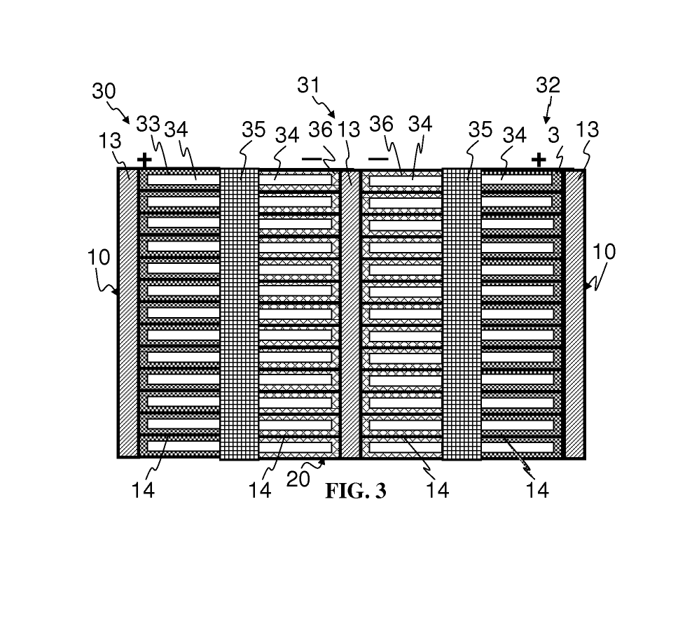

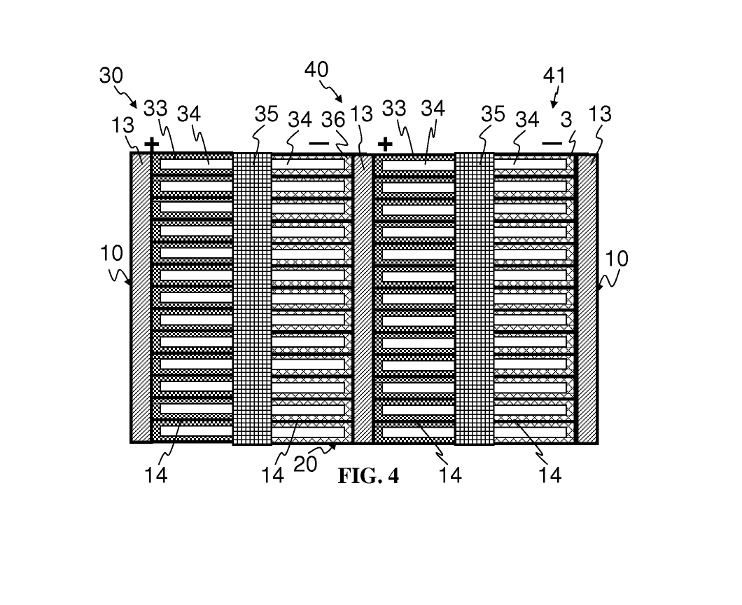

The electrode plates 10 can be configured as monopolar electrodes, generally indicated at 30, 31 and 32, as illustrated in FIG. 3 or a bipolar electrode, generally indicated at 40, as illustrated in FIG. 4. When the same active material (positive active material 33 or negative active material 36) is pasted in both sides of the electrode plate 10, the monopolar electrode 30, 31, 32 is formed, and when the negative active material 36 is pasted in one side of the electrode plate 10 and the positive active material 33 is pasted in another side, the bipolar electrode 40 is formed.

Referring to FIGS. 3 and 4, cross-sections of a lead acid battery, according to embodiments of the present invention, are shown. As illustrated in FIG. 3, one embodiment of a monopolar configuration for the lead acid battery, according to the present invention, is shown. As illustrated in FIG. 4, one embodiment of a bipolar configuration for the lead acid battery, according to the present invention, is shown. As illustrated in the embodiments, the lead acid battery may include a hybrid electrolyte system including an electrolyte, a gel 34, and a separator 35. The gel 34 may be a sulfuric acid gel, which is gelled by fumed silica or by other chemical methods. The separator 35 may be porous polymer materials, adsorbed glass mat (AGM) and other suitable materials. The electrolyte is immobilized by the gel 34 and AGM 35. The gel 34 plays two roles: one is to storage the acid, and another is to give the channels/paths for the ions to easily migrate/diffuse into the whole active materials. It should be appreciated that such hybrid electrolyte system can reduce the separation distance between the positive plate and negative plate, and decrease the internal resistance, and increase the utilization of the active materials, and enhance the charge acceptance and cycle life.

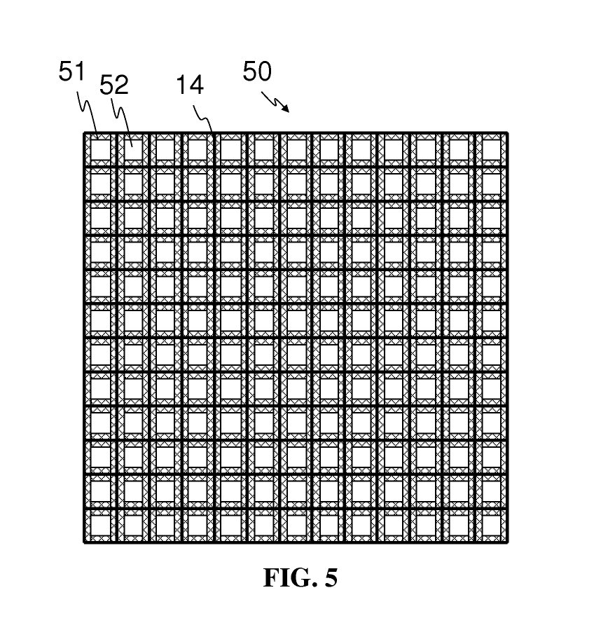

The electrode plate 10 may have other grid patterns. For example, the pattern can be rectangular, diamond, and honeycomb. FIG. 5 illustrates an electrode plate 50 with a grid structure of a rectangular pattern, which has been pasted with an active material 51. In one embodiment, the active material 51, and the gelled electrolyte 52 are shown for the electrode 50.

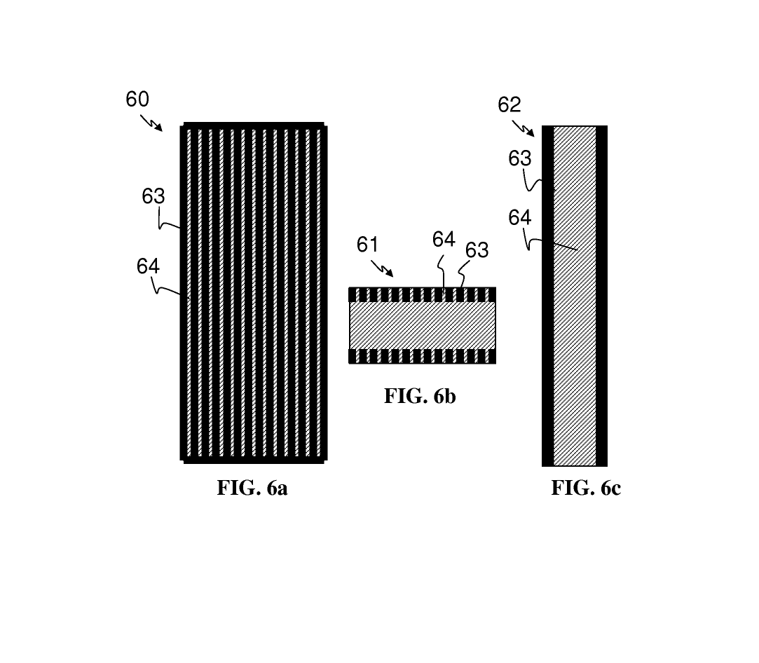

FIGS. 6a, 6b and 6c illustrate a Pb-Sn composite 60, which can be used to make the basement 13 and the grid 14 of the electrode plate 10. This composite 60 includes a tin/tin alloy micro-grid 63 and a pure lead bulk 64. The term “micro-grid” means that the edge width and/or mesh dimensions of the grid are in micro scale, which may be from about several micrometers to about several hundred micrometers. FIG. 6a shows a surface view of the composite 60 with a bar micro-grid 63, and FIG. 6b shows a bottom cross-sectional view of FIG. 6a, and FIG. 6c shows a side cross-sectional view of FIG. 6a. The thickness of the micro-grid 63 in the composite 60 may be from several micrometers to about several hundred micrometers. The micro-grid 63 may be pure tin (purity >98%) or lead tin (PbSn) alloy, and the bulk 64 is a pure lead (purity >98%). The pure lead bulk 64 may have a thickness from about several micrometers to about several hundred micrometers. It should be appreciated that the composite 60 with such micro-grid internal structure can have a good electrical conductivity under the electrochemical environment and be corrosion resistant as well. It should also be appreciated that the composite 60 can be made by high pressure, kinetic spray, or other methods.

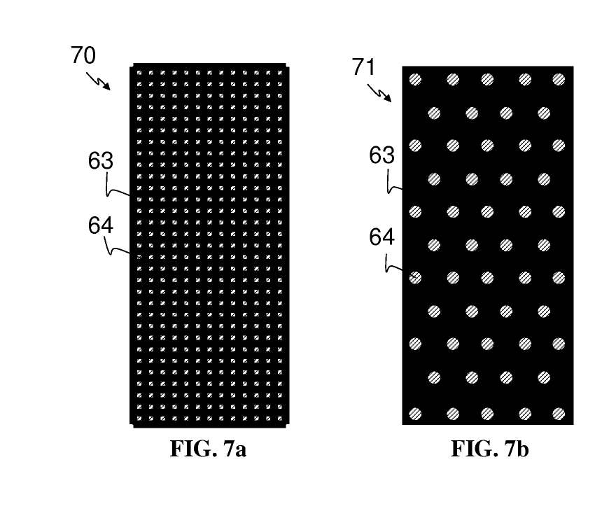

The pattern for the micro-grid 63 may be any other suitable pattern, such as circle, rectangular, diamond, and honeycomb patterns. FIGS. 7a and 7b show the surface view of a composite 70 with a rectangular micro-grid 63 and a circle micro-grid 63, respectively. It should be appreciated that the complex grid system 10 can be made by a Pb-Sn composite 60 with a micro-grid internal structure.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A lead acid battery comprising:
at least one electrode plate having a complex grid system; and
a hybrid electrolyte system.

2. A lead acid battery as set forth in claim 1 wherein said complex grid system comprises a conductive and corrosive resistant basement and a grid having edges with a sub-grid structure.

3. A lead acid battery as set forth in claim 2 wherein said basement is one of a composite, metal coated with conductive and corrosive resistant film, conductive polymer, and lead/lead alloy.

4. A lead acid battery as set forth in claim 2 wherein at least one of said grid and said sub-grid is one of a composite, metal coated with conductive and corrosive resistant film, polymer coated with conductive and corrosive resistant film, conductive polymer, and lead/lead alloy.

5. A lead acid battery as set forth in claim 3 or 4 wherein said composite comprises a lead bulk and a tin or lead tin alloy micro-grid.

6. A lead acid battery as set forth in claim 3 or 4 wherein said composite has a micro-grid for an internal structure.

7. A lead acid battery as set forth in claim 5 wherein said micro-grid is a grid having at least one of edge width and mesh dimensions in micrometer scale.

8. A lead acid battery as set forth in claim 6 wherein said micro-grid is a grid having at least one of edge width and mesh dimensions in micrometer scale.

9. A lead acid battery as set forth in claim 2 wherein said grid has a pattern of at least one of a bar, circle, diamond, honeycomb, and rectangular.

10. A lead acid battery as set forth in claim 7 wherein said grid has a pattern of at least one of a bar, circle, diamond, honeycomb, and rectangular.

11. A lead acid battery as set forth in claim 7 wherein said grid has a pattern of at least one of a bar, circle, diamond, honeycomb, and rectangular.

12. A lead acid battery as set forth in claim 2 wherein said sub-grid is a grid with small mesh sizes from approximately 0.7 square millimeter to approximately 320 square millimeters.

13. A lead acid battery as set forth in claim 12 wherein said mesh is at least one of a circle, diamond, honeycomb, and rectangular pattern.

14. A lead acid battery as set forth in claim 1 wherein said hybrid electrolyte system comprises a sulfuric acid gel and adsorbed glass mat, wherein said gel is in grids of said electrode plate and said adsorbed glass mat is in between a plurality of said electrode plate.

15. A lead acid battery as set forth in claim 1 wherein said electrode plate has at least one of a monopolar configuration or bipolar configuration.

16. A lead acid battery comprising:
at least one electrode plate having a complex grid system and a hybrid electrolyte system, wherein said complex grid system comprises a conductive and corrosive resistant basement and a grid having edges with a sub-grid structure and said hybrid electrolyte system comprises a sulfuric acid gel and adsorbed glass mat, wherein said gel is in said grid of said electrode plate and said adsorbed glass mat is in between a plurality of said electrode plate.

17. A lead acid battery as set forth in claim 16 wherein said basement is one of a composite, metal coated with conductive and corrosive resistant film, conductive polymer, and lead/lead alloy.

18. A lead acid battery as set forth in claim 16 wherein at least one of said grid and said sub-grid is one of a composite, metal coated with conductive and corrosive resistant film, polymer coated with conductive and corrosive resistant film, conductive polymer, and lead/lead alloy.
